(19) United States
(12) Patent Application Publication
(10) Pub. No.: US 2003/0076641 A1
(43) Pub. Date: Apr. 24, 2003

(54) Circuit board having interference preventing device

(76) Inventors: Wen Hsiung Lin, Chong Ho City (TW); I Tao Chen, Chong Ho City (TW)

Correspondence Address: Wen Hsiung LIN, P.O. Box 10-69, Chong Ho, Taipei, TW

(21) Appl. No.: 09/982,889

(22) Filed: Oct. 22, 2001

(51) Int. Cl. H02H 3/00

(52) U.S. Cl. 361/72

(57) ABSTRACT

A circuit board includes two or more electric members attached onto the board, and two or more peripheral frames attached onto the board and disposed around the electric member respectively, for separating electric member from each other and for preventing the electric member from being interfered with each other. The peripheral frame are preferably conductive and/or preferably grounded for facilitating the frequencies separating between the electric members. The board includes two or more peripheral lines, and the peripheral frames are engaged onto the peripheral line.

### BACKGROUND OF THE INVENTION

1. Field of the Invention

The present invention relates to a circuit board, and more particularly to a circuit board having a device for preventing an interference formed or occurred between the electric elements or parts of the circuit board.

2. Description of the Prior Art

Typical circuit boards comprise a board body, and a number of electric members or parts secured or attached onto the board body. The board body may include a printed electric circuit provided thereon before the electric members or parts are secured or attached onto the board body. Some of the electric members or parts, such as the oscillating devices, oscillators, mixers, etc., may generate different or various kinds of frequencies, such that the electric members or parts may be interfered by the other electric members or parts. For some of the circuit boards, one or more conductor housings or covers are required to be manufactured according to the shapes of the electric members or parts that may generate various kinds of frequencies, and are then engaged onto the electric members or parts and then secured to the board body by welding processes. However, it will be difficult to weld and secure the housings or covers onto the electric members or parts. In addition, the welder materials may be electrically coupled or contacted between the electric members or parts, such that the electric members or parts may have a good chance to be shortaged by the welder materials.

The present invention has arisen to mitigate and/or obviate the afore-described disadvantages of the conventional circuit boards.

### SUMMARY OF THE INVENTION

The primary objective of the present invention is to provide a circuit board including a device for preventing an interference formed or occurred between the electric elements or parts of the circuit board.

The other objective of the present invention is to provide a circuit board including an interference preventing device that may be provided and attached onto the circuit board before the electric elements or parts are attached or secured onto the circuit board.

In accordance with one aspect of the invention, there is provided a circuit board comprising a board body, a first electric member and at least one second electric member attached onto the board body, and a first peripheral frame and at least one second peripheral frame attached onto the board body and disposed around the first electric member and the second electric member respectively, for separating the first electric member and the second electric member from each other and for preventing the first electric member and the second electric member from being interfered with each other.

The first peripheral frame and the second peripheral frame are preferably conductive for preventing the frequencies generated by the first electric member and the second electric member from being interfered with each other. The first peripheral frame and the second peripheral frame are preferably grounded for facilitating the frequencies separating between the electric members.

The board includes a first peripheral line and at least one second peripheral line provided thereon, the first peripheral frame and the second peripheral frame are engaged onto the first peripheral line and the second peripheral line.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a circuit board in accordance with the present invention;

FIG. 2 is a top plan view of the circuit board, before the electric elements have been attached onto the circuit board; and

FIG. 3 is a perspective view of the circuit board which includes an interference preventing device provided and attached thereon before the electric elements have been attached onto the circuit board.

### DETAILED DESCRIPTION OF THE PREFERRED EMBODIMENT

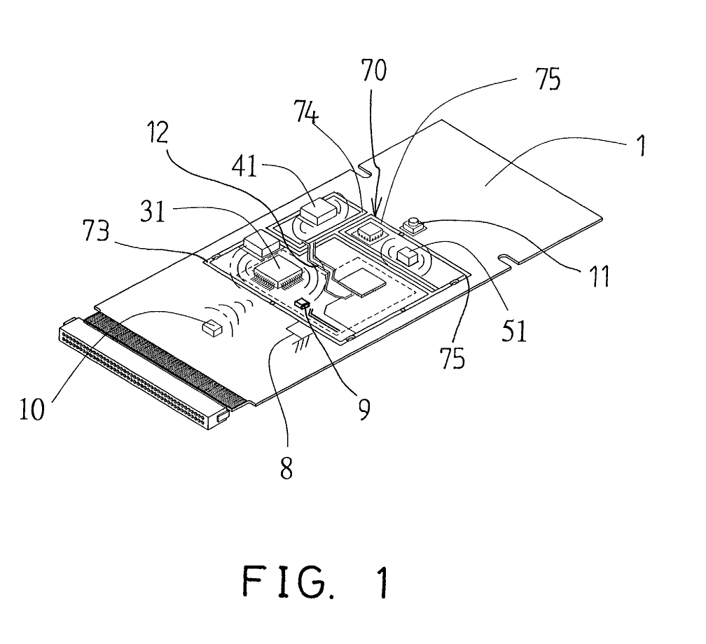

Referring to the drawings, and initially to FIG. 1, a circuit board in accordance with the present invention comprises a board body 1, and a number of electric parts or members 9, 10, 11, 31, 41, 51 secured or attached onto the board body 1. The board body 1 may include a printed electric circuit 12 provided or applied thereon before the electric members 9, 10, 11, 31, 41, 51 are secured or attached onto the board body 1. Some of the electric members 9, 10, 11, 31, 41, 51 may be the oscillating devices, the oscillators, the mixers, or the like and may generate different or various kinds of frequencies.

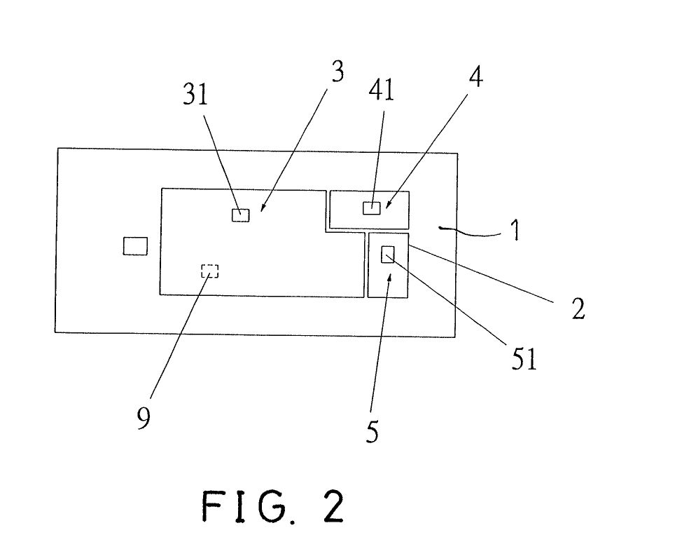

Referring next to FIG. 2, the board body 1, particularly the upper surface of the board body 1 is separated or divided into one or more areas 3, 4, 5 by providing or drawing or applying the peripheral lines 2 thereon, during the circuit layout procedures, for receiving and/or separating the electric members 31, 41, 51 that may generate different or various kinds of frequencies. For example, the electric members 9, 31 that may generate higher frequencies are disposed within the area 3, the other electric members 41 that may generate intermediate frequencies are disposed within the other area 4, and the further electric members 51 that may generate lower frequencies are disposed within the further area 5.

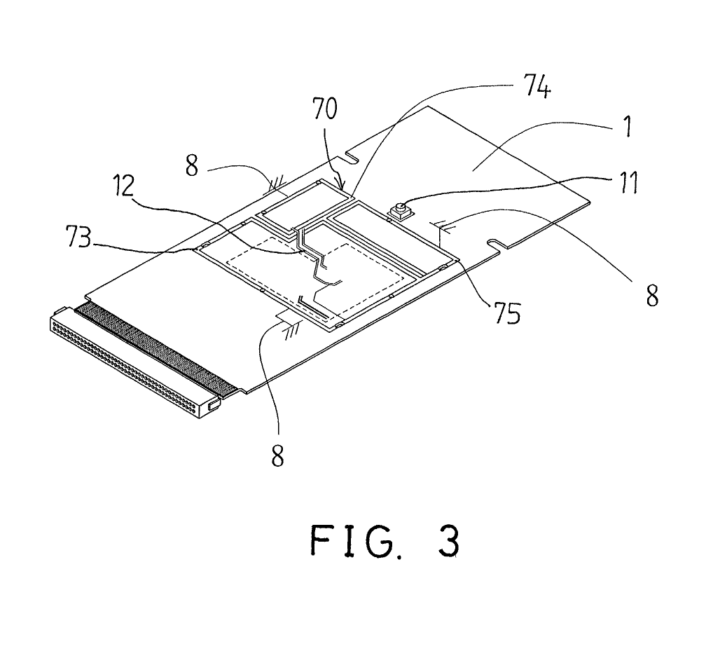

Referring next to FIG. 3, after the upper surface of the board body 1 has been separated or divided into one or more areas 3, 4, 5 by the peripheral lines 2, during the circuit layout procedures, an interference preventing device 70 may be provided and attached onto the circuit board body 1 before the electric members 9, 10, 31, 41, 51 are attached or secured onto the circuit board body 1. For example, the interference preventing device 70 may include one or more peripheral frames 73, 74, 75 provided and attached onto the circuit board body 1, such as attached on the predetermined peripheral lines 2 respectively by the so-called surface mount technology.

The peripheral frames 73, 74, 75 of the interference preventing device 70 are preferably made of electric conductive materials, such as the copper, the alloys thereof, or the like, and may be grounded at grounds 8. The electric members 9, 10, 31, 41, 51 may then be attached or secured onto the circuit board body 1 after the conductive peripheral frames 73, 74, 75 of the interference preventing device 70 have been attached or secured onto the circuit board body 1. The conductive peripheral frames 73, 74, 75 that are grounded or that have not been grounded may be used for separating the electric members 9, 31, 41, 51 of different frequencies from each other, and for preventing the electric members 9, 31, 41, 51 from being interfered with each other or from being interfered by the other electric members 10. It is preferable that the conductive peripheral frames 73, 74, 75 are preferably grounded 8 for facilitating the frequencies separating effect and for further preventing the electric members 9, 31, 41, 51 from being interfered with each other or from being interfered by the other electric members 10.

It is to be noted that the conductive peripheral frames 73, 74, 75 may be made or formed with an area greater than that required. For example, the conductive peripheral frame 73 is design and provided for receiving the electric member 31 therein. Some times later, when the other electric members 9 are further required and have the frequency close to that of the electric member 31, the electric members 9 may then also be disposed in the area 3 or disposed within the conductive peripheral frame 73, for allowing the electric members 9, 31 that have similar frequencies to be received and retained in the same conductive peripheral frame 73. Relatively, the electric members 9, 31 that have similar frequencies and that are received and retained in the same conductive peripheral frame 73 may also be prevented from being interfered by the other electric members 10 that are located outside of the conductive peripheral frames 73, 74, 75, or from being interfered by the other electric members 41, 51 that are located within the other conductive peripheral frames 73, 74, 75.

Accordingly, the circuit board in accordance with the present invention includes a device for preventing an interference formed or occurred between the electric elements or parts of the circuit board. The interference preventing device may be provided and attached onto the circuit board before the electric elements or parts are attached or secured onto the circuit board.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A circuit board comprising:
a board body,
a first electric member attached onto said board body, and
a peripheral frame attached onto said board body and disposed around said first electric member for preventing said first electric member from being interfered by other electric members.

2. A circuit board comprising:
a board body including a first surface,
a first electric member attached onto said first surface of said board body, and
a peripheral frame attached onto said first surface of said board body and disposed around said first electric member for preventing said first electric member from being interfered by other electric members.

3. A circuit board comprising:
a board body,
a first electric member and at least one second electric member attached onto said board body, and
a first peripheral frame and at least one second peripheral frame attached onto said board body and disposed around said first electric member and said at least one second electric member respectively, for preventing said first electric member and said at least one second electric member from being interfered with each other.

4. The circuit board according to claim 3, wherein said first peripheral frame and said at least one second peripheral frame are conductive.

5. The circuit board according to claim 3, wherein said first peripheral frame and said at least one second peripheral frame are grounded.

6. The circuit board according to claim 3, wherein said board includes a first peripheral line and at least one second peripheral line provided thereon, said first peripheral frame and said at least one second peripheral frame are engaged onto said first peripheral line and said at least one second peripheral line.
